(19) United States
(12) Patent Application Publication
(10) Pub. No.: US 2019/0151748 A1
(43) Pub. Date: May 23, 2019

(54) ELECTRONIC BINGO SYSTEM

(71) Applicant: Gregory Ewald, Gainesville, GA (US)

(72) Inventor: Gregory Ewald, Gainesville, GA (US)

(21) Appl. No.: 16/108,083

(22) Filed: Aug. 21, 2018

Related U.S. Application Data
(60) Provisional application No. 62/548,353, filed on Aug. 21, 2017.

(51) Int. Cl. A63F 3/06; A63F 13/213; A63F 13/335; G10L 15/22

(52) U.S. Cl. CPC A63F 3/0645; G10L 15/22; A63F 13/335; A63F 13/213

(57) ABSTRACT

Implementations of an electronic bingo system are provided. In some implementations, the electronic bingo system comprises a portable computing device configured to take a picture of a bingo card and store an image of the bingo card on the portable computing device, receive an indication of a ball in play during a game of live bingo, determine if the image has an indication of ball in play printed on the image; recognize when a winning bingo pattern exists for the image based on the received indications of a ball in play and the indications printed on the loaded bingo card; and alert a user of the portable computing device when a winning bingo pattern exists for the loaded bingo card. In some implementations, the portable computing device is a mobile phone.

### CROSS REFERENCE TO RELATED APPLICATION

This application claims the benefit of U.S. Patent Application Ser. No. 62/548,353, which was filed on Aug. 21, 2018, and is incorporated herein by reference in its entirety.

### TECHNICAL FIELD

This disclosure relates to implementations of an electronic bingo system.

### BACKGROUND

There currently exist sophisticated electronic bingo systems used to play bingo in physical bingo hall locations (i.e., not on-line) such as at casinos or charity events. These electronic bingo systems include a central computer and sophisticated, specialized bingo card trackers that are assigned and distributed to the bingo players at the bingo halls. The bingo card trackers download electronic bingo cards, which may be electronic representations of physical bingo cards, and track the downloaded electronic bingo cards to recognize bingo patterns on the electronic bingo cards during the progress of bingo games. The electronic bingo systems connect the bingo card trackers with a central computer that electronically transmits each ball in play to the bingo card trackers. These electronic bingo systems are complex and costly.

### BRIEF DESCRIPTION OF THE DRAWINGS

FIG. 1 illustrates an implementation of an example environment of an electronic bingo system according to the present disclosure.

FIG. 2 illustrates an example computer system, which may be used with implementations of the present disclosure.

FIG. 3 illustrates an implementation of an example method for electronic bingo in the environment of FIG. 1 according to the present disclosure.

### DETAILED DESCRIPTION

Implementations of an electronic bingo system are provided.

In some implementations, the electronic bingo system of the present disclosure is configured to provide a simplified electronic bingo system and method that replaces the costly existing bingo card trackers.

In some implementations, the electronic bingo system is configured to use a portable computing device (such as a mobile phone) as a bingo card tracker. In some implementations, the electronic bingo system is configured to use a player's portable computing device to function as a bingo card tracker.

In this way, a bingo hall may operate at a reduced cost by allowing players to use their own portable computing devices as bingo card trackers instead of the bingo hall supplying bingo card tracker. Furthermore, implementations of an electronic bingo system of the present disclosure allow players to play electronic bingo at a bingo hall that is not equipped for electronic bingo by allowing players to play electronic bingo using their portable computing device.

In some implementations, to play bingo using a portable computing device, a bingo application according to present disclosure is downloaded to the portable computing device. In some implementations, the bingo application is configured to load a physical bingo card onto the portable computing device by using the portable computing device's camera. In some implementations, a picture of a bingo card is taken by the player and used by the bingo application. In some implementations, the bingo application is configured to play bingo using the loaded card.

In some implementations, during a live game of bingo at a bingo hall where balls may be output from a hopper, the bingo application is configured to receive an input of the ball in play, determine whether the card that has been uploaded to the application has an indication of the ball in play on the card, display the card and mark the indication of the ball in play if present on the card (e.g., so that the player can see the progress of the game and recognize a bingo pattern), recognize when a bingo pattern exists from the balls played, and alert the player when a bingo pattern is recognized. In this way, complex equipment need not be provided be the bingo hall and players can use their mobile phones to assist them in playing bingo. In some implementations, no central server is required; a player can play bingo on his/her mobile phone locally.

In some implementations, the bingo application is configured to play a plurality of bingo cards simultaneously.

In some implementations, the bingo application can receive a ball in play (e.g., a ball output from the hopper) in any suitable manner. For example, in some implementations, the player may manually input the ball in play to the bingo application. In some implementations, the bingo application may be configured to link with a network to receive electronically an input of the balls in play. In some implementations, the bingo application may include electronic voice recognition and may receive an audible input of the ball in play (e.g., from an announcer).

In some implementations, the bingo application is configured to alert the user that a card has a bingo pattern in any suitable manner. In some implementations, the bingo application is configured to link with a network to report a winning card to a central computer.

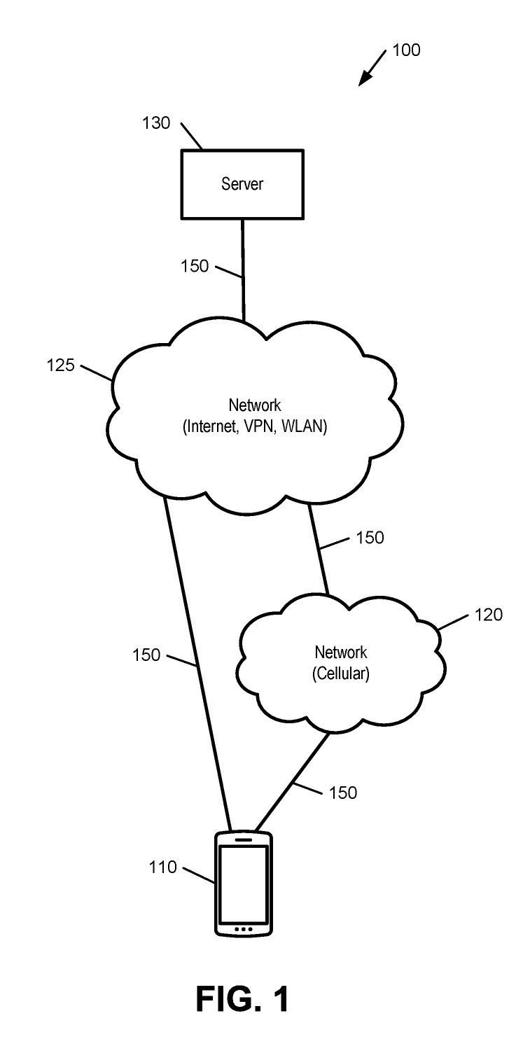

FIG. 1 illustrates an implementation of an example environment 100 of an electronic bingo system according to the present disclosure. As shown in FIG. 1, in some implementations, the environment 100 may include one or more client devices 110, a wireless cellular network 120, a network 125, and one or more servers 130.

In some implementations, a client device 110 may be used by users of the electronic bingo system to play electronic bingo. In some implementations, a client device 110 may be used by users of the electronic bingo system as bingo card trackers.

The client device 110 is depicted as a mobile phone, but the client device 110 may comprise any type of portable computing device, such as a laptop, cellular phone, a smart device, a mobile telephone, a tablet-style computer, or any other handheld electronic device capable of wireless communication.

In some implementations, the client device 110 is configured to interact with the server 130 via an application, such as a native application, residing on the client device 110.

In some implementations, the client device 110 includes hardware, software, or embedded logic components or a combination of two or more such components and is configured to carry out the appropriate functions implemented or supported by the client device 110.

In some implementations, the client device 110 may include one or more processors, one or more memories, one or more displays, one or more interfaces, one or more components capable of inputting data, one or more components capable of outputting data, one or more components capable of communicating with any other component of the environment 100 of the electronic bingo system, or any other component suitable for a particular purpose.

In some implementations, the client device 110 is configured to access networks 120 and/or 125. In some implementations, the client device 110 is configured to communicate with the server 130.

In some implementations, the client device 110 can connect to the network 125 through a wireless cellular network 120, such as GPRS-based and CDMA-based wireless networks, as well as 802.16 WiMax and long-range wireless data networks.

In some implementations, components of the electronic bingo system environment 100 may communicate with any other component of the environment 100 over network 125. Network 125 may be any suitable network. In some implementations, for example, one or more portions of network 125 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another network 125, or a combination of two or more of the foregoing.

In some embodiments, components of the electronic bingo system environment 100 may be configured to communicate over links 150. Links 150 may connect components of the environment 100 to networks 120, 125 or to each other. In some implementations, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links.

In particular embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links 150. Links 150 may be the same or different throughout the environment 100.

In some implementations, the server 130 may include a processor, memory, user accounts, and one or more modules to perform various functions.

In some implementations, each server 130 may be a unitary server or may be a distributed server spanning multiple computers or multiple datacenters. Each server 130 may be of various types, such as, for example and without limitation, web server, file server, application server, exchange server, database server, or proxy server.

In some implementations, each server 130 may include hardware, software, or embedded logic components or a combination of two or more such components for carrying out the appropriate functionalities implemented or supported by each server 130. For example, a web server is generally capable of hosting websites containing web pages or particular elements of web pages.

More specifically, a web server may host HTML files or other file types, or may dynamically create or constitute files upon a request, and communicate them to the client device 110 in response to HTTP or other requests from the client device 110. A database server is generally capable of providing an interface for managing data stored in one or more data stores.

In some implementations, one or more data storages may be communicatively linked to the one or more servers 130 via one or more links 150. In some implementations, data storages may be used to store various types of information. In some implementations, the information stored in the data storages may be organized according to specific data structures.

In particular embodiments, each data storage may be a relational database. In some implementations, particular embodiments may provide interfaces that enable the server 130 or client device 110 to manage, e.g., retrieve, modify, add, or delete, the information stored in the data storage.

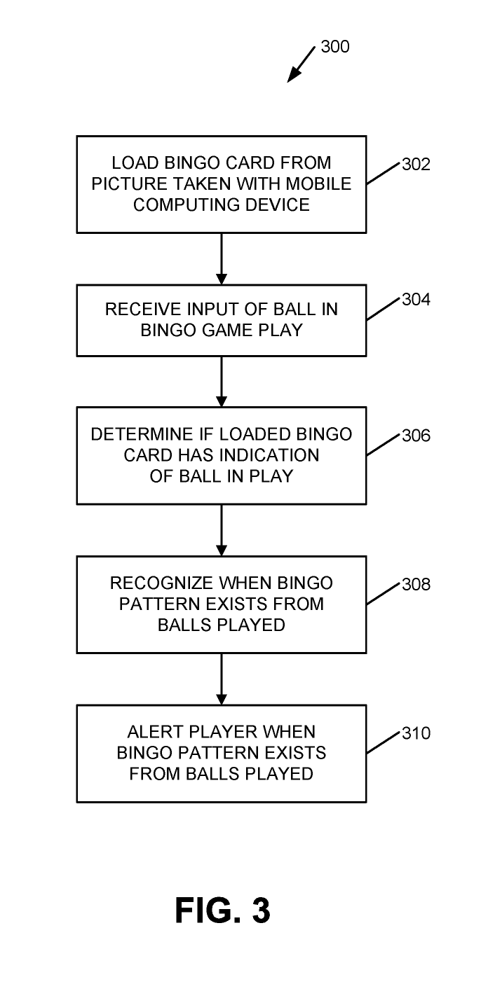

FIG. 3 illustrates an implementation of an example method 300 for playing electronic bingo in the environment 100 of FIG. 1 according to the present disclosure.

In some implementations, the method 300 comprises loading 302 on a portable computing device (e.g., a client device) 110 having a bingo application of the present disclosure operative thereon, a bingo card from a picture taken with the portable computing device 110.

In some implementations, the bingo card comprises a physical bingo card. In some implementations, the bingo card comprises any other suitable form of bingo card.

In some implementations, the loading 302 comprises loading a plurality of bingo cards from a plurality of pictures respectively.

In some implementations, the method 300 comprises receiving 304 an input of a ball in play to the portable computing device 110.

In some implementations, the ball in play is during a game of live bingo. In some implementations, the game of live bingo is played at a bingo hall.

In some implementations, the ball in play is output from a hopper in the game of live bingo.

In some implementations, the receiving 304 comprises receiving the input of a ball in play to the portable computing device 110 manually by a user of the method 300. In some implementations, the receiving 304 comprises receiving the input of a ball in play to the portable computing device 110 manually using an input device of the portable computing device 110. In some implementations, the bingo application is configured to display a user interface for manually inputting the game in play.

In some implementations, the receiving 304 comprises receiving the input of a ball in play to the portable computing device 110 electronically transmitted via a link 150 and/or a network 125 from a central computing device (e.g., a server) 130.

In some implementations, the network 125, the link 150, and the central computing device 130 are operated by a bingo hall to conduct the play of electronic bingo.

In some implementations, the receiving 304 comprises receiving the input of a ball in play to the portable computing device 110 audibly through an electronic voice recognition feature of the portable computing device 110. In some implementations, the receiving 304 is audibly from an announcer.

In some implementations, the receiving 304 comprises receiving the input of a ball in play to the portable computing device 110 in any other suitable manner.

In some implementations, the method 300 comprises determining 306 by the portable computing device 110 if a loaded bingo card has an indication of ball in play.

In some implementations, the determining 306 comprises comparing the input of the ball in play (e.g., letter and/or number) to the available indications on the loaded bingo card. In some implementations, if a match is found from the comparing, then it is determined that the loaded bingo card has an indication of the ball in play.

In some implementations, the determining 306 comprises determining if a loaded bingo card has an indication of ball in play by the portable computing device 110 in any other suitable manner. In some implementations, technology similar to facial recognition may be used for the determining step.

One of ordinary skill in the art with the benefit of this disclosure will know how to make an application configured to determine whether a loaded bingo card has an indication of a ball in play.

In some implementations, the method 300 comprises recognizing 308 by the portable computing device 110 when a winning bingo pattern exists from the balls played for the bingo card loaded to the portable computing device 110.

In some implementations, the recognizing 308 comprises recognizing by the portable computing device 110 when a bingo pattern exists from the balls played for the loaded bingo card in any other suitable manner.

One of ordinary skill in the art with the benefit of this disclosure will know how to make an application configured to recognize when a bingo pattern exists from balls played for a bingo card.

In some implementations, the method 300 comprises alerting 310 a user by the portable computing device 110 when a bingo pattern exists from the balls played for the bingo card loaded to the portable computing device 110.

In some implementations, the alerting 310 comprises alerting a user by the portable computing device 110 displaying text indicating the alert. In some implementations, the alerting 310 comprises alerting a user by the portable computing device 110 displaying graphics indicating the alert.

In some implementations, the alerting 310 comprises alerting a user by the portable computing device 110 by producing a sound indicating the alert.

In some implementations, the alerting 310 comprises alerting a user by the portable computing device 110 in any other suitable manner.

In some implementations, the method 300 further comprises reporting a winning card by the portable computing device 110 when a bingo pattern exists from the balls played for the loaded bingo card.

In some implementations, the reporting is by the portable computing device 110 to the central computing device 130 transmitted via the link 150 and/or the network 125.

In some implementations, the method 300 further comprises the portable computing device 110 playing bingo using a plurality of bingo cards simultaneously.

In some implementations, the method 300 further comprises the portable computing device 110 playing bingo automatically with the loaded picture of the bingo card.

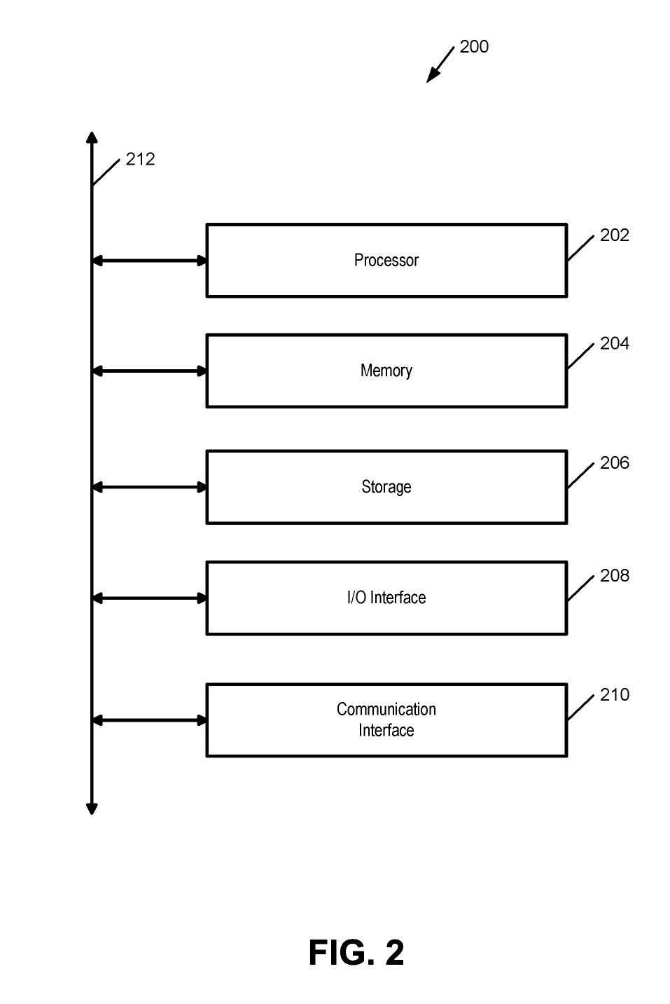

FIG. 2 illustrates an example computer system 200, which may be used with some implementations of the present invention. This disclosure contemplates any suitable number of computer systems 200.

This disclosure contemplates computer system 200 taking any suitable physical form. In some implementations, as an example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these.

In some implementations, where appropriate, computer system 200 may include one or more computer systems 200; be unitary or distributed; span multiple locations; span multiple machines; or reside in a cloud, which may include one or more cloud components in one or more networks.

In some implementations, where appropriate, one or more computer systems 200 may perform without substantial spatial or temporal limitation one or more steps of one or more methods described or illustrated herein. In some implementations, as an example and not by way of limitation, one or more computer systems 200 may perform in real time or in batch mode one or more steps of one or more methods described or illustrated herein. In some implementations, one or more computer systems 200 may perform at different times or at different locations one or more steps of one or more methods described or illustrated herein, where appropriate.

In some implementations, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In some implementations, processor 202 includes hardware for executing instructions, such as those making up a computer program. In some implementations, as an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206.

In some implementations, processor 202 may include one or more internal caches for data, instructions, or addresses. The present disclosure contemplates processor 202 including any suitable number of any suitable internal caches, where appropriate. In some implementations, as an example and not by way of limitation, processor 202 may include one or more instruction caches, one or more data caches, and one or more translation look-aside buffers (TLBs).

In some implementations, instructions in the instruction caches may be copies of instructions in memory 204 or storage 206, and the instruction caches may speed up retrieval of those instructions by processor 202.

In some implementations, data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data.

In some implementations, the data caches may speed up read or write operations by processor 202. In some implementations, the TLBs may speed up virtual-address translation for processor 202.

In some implementations, processor 202 may include one or more internal registers for data, instructions, or addresses. The present disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In some implementations, memory 204 includes main memory for storing instructions for processor 202 to execute or data for processor 202 to operate on. In some implementations, as an example and not by way of limitation, computer system 200 may load instructions from storage 206 or another source (such as, for example, another computer system 200) to memory 204.

In some implementations, processor 202 may then load the instructions from memory 204 to an internal register or internal cache. In some implementations, to execute the instructions, processor 202 may retrieve the instructions from the internal register or internal cache and decode them.

In some implementations, during or after execution of the instructions, processor 202 may write one or more results (which may be intermediate or final results) to the internal register or internal cache. In some implementations, processor 202 may then write one or more of those results to memory 204.

In some implementations, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere).

In some implementations, one or more memory buses (which may each include an address bus and a data bus) may couple processor 202 to memory 204. In some implementations, bus 212 may include one or more memory buses, as described below.

In some implementations, one or more memory management units (MMUs) reside between processor 202 and memory 204 and facilitate accesses to memory 204 requested by processor 202.

In some implementations, memory 204 includes random access memory (RAM). In some implementations, this RAM may be volatile memory, where appropriate.

In some implementations, where appropriate, this RAM may be dynamic RAM (DRAM) or static RAM (SRAM). Moreover, in some implementations, where appropriate, this RAM may be single-ported or multi-ported RAM. The present disclosure contemplates any suitable RAM.

In some implementations, memory 204 may include one or more memories 204, where appropriate. Although this disclosure describes and illustrates particular memory, this disclosure contemplates any suitable memory.

In some implementations, storage 206 includes mass storage for data or instructions. In some implementations, as an example and not by way of limitation, storage 206 may include an HDD, a floppy disk drive, flash memory, an optical disc, a magneto-optical disc, magnetic tape, or a Universal Serial Bus (USB) drive or a combination of two or more of these.

In some implementations, storage 206 may include removable or non-removable (or fixed) media, where appropriate. In some implementations, storage 206 may be internal or external to computer system 200, where appropriate. In some implementations, storage 206 is non-volatile, solid-state memory.

In some implementations, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form.

In some implementations, storage 206 may include one or more storage control units facilitating communication between processor 202 and storage 206, where appropriate. In some implementations, where appropriate, storage 206 may include one or more storages 206. Although this disclosure describes and illustrates particular storage, this disclosure contemplates any suitable storage.

In some implementations, I/O interface 208 includes hardware, software, or both providing one or more interfaces for communication between computer system 200 and one or more I/O devices. In some implementations, computer system 200 may include one or more of these I/O devices, where appropriate.

In some implementations, one or more of these I/O devices may enable communication between a person and computer system 200. In some implementations, as an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

In some implementations, an I/O device may include one or more sensors. This disclosure contemplates any suitable I/O devices and any suitable I/O interfaces 208 for them.

In some implementations, where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In some implementations, communication interface 210 includes hardware, software, or both providing one or more interfaces for communication (such as, for example, packet-based communication) between computer system 200 and one or more other computer systems 200 or one or more networks.

In some implementations, as an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it.

In some implementations, as an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these.

In some implementations, one or more portions of one or more of these networks may be wired or wireless. In some implementations, as an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In some implementations, computer system 200 may include any suitable communication interface 210 for any of these networks, where appropriate. In some implementations, communication interface 210 may include one or more communication interfaces 210, where appropriate. Although this disclosure describes and illustrates a particular communication interface, this disclosure contemplates any suitable communication interface.

In some implementations, bus 212 includes hardware, software, or both coupling components of computer system 200 to each other. In some implementations, as an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these.

In some implementations, bus 212 may include one or more buses 212, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. In some implementations, as an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate.

Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101.

This disclosure contemplates one or more computer-readable storage media implementing any suitable storage. In some implementations, a computer-readable storage medium implements one or more portions of processor 402 (such as, for example, one or more internal registers or caches), one or more portions of memory 404, one or more portions of storage 406, or a combination of these, where appropriate.

In some implementations, a computer-readable storage medium implements RAM or ROM. In some implementations, a computer-readable storage medium implements volatile or persistent memory.

In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate.

In some implementations, software includes one or more application programming interfaces (APIs). This disclosure contemplates any suitable software written or otherwise expressed in any suitable programming language or combination of programming languages.

In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code).

In some implementations, software is expressed in JAVA. In some implementations, software is expressed in Hyper Text Markup Language (HTML), Extensible Markup Language (XML), or other suitable markup language.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example. it will apparent to one of ordinary skill in the art that the invention may be used with any electronic network service, even if it is not provided through a website.

Any computer-based system that provides networking functionality can be used in accordance with the present invention even if it relies, for example, on e-mail, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend.

1. A computer-implemented method for playing electronic bingo during a live bingo game, the method comprising:
loading a bingo card on a portable computing device by taking a picture of the bingo card using the portable computing device and storing an image of the bingo card on the portable computing device wherein the portable computing device is a mobile phone;
receiving by the portable computing device an indication of a ball in play during a game of live bingo;
determining by the portable computing device if the loaded bingo card has an indication of the ball in play printed on the loaded bingo card based on the received indication of a ball in play;
recognizing by the portable computing device when a winning bingo pattern exists for the loaded bingo card based on the received indications of a ball in play and the indications printed on the loaded bingo card; and
alerting a user of the portable computing device when a winning bingo pattern exists for the loaded bingo card.

2. The computer-implemented method of claim 1 wherein receiving by the portable computing device an indication of a ball in play comprises receiving by the portable computing device an indication of a ball in play manually entered by a user of the portable computing device using an input device of the portable computing device.

3. The computer-implemented method of claim 2, the method further comprising displaying a user interface for manually inputting the game in play.

4. The computer-implemented method of claim 1 wherein receiving by the portable computing device an indication of a ball in play comprises receiving by the portable computing device an indication of a ball in play over a network from a central computing device.

5. The computer-implemented method of claim 1 wherein receiving by the portable computing device an indication of a ball in play comprises receiving by the portable computing device a sound input of a ball in play wherein the portable computing device uses voice recognition to determine the ball in play.

6. The computer-implemented method of claim 1 further comprising reporting a winning card by the portable computing device when a bingo pattern exists from the balls played for the loaded bingo card over a network to a first computing device.

7. A device for playing electronic bingo during a live bingo game, the device comprising:
a portable computing device configured to take a picture of a bingo card and store an image of the bingo card on the portable computing device, receive an indication of a ball in play during a game of live bingo, determine if the image has an indication of ball in play printed on the image; recognize when a winning bingo pattern exists for the image based on the received indications of a ball in play and the indications printed on the loaded bingo card; and alert a user of the portable computing device when a winning bingo pattern exists for the loaded bingo card wherein the portable computing device is a mobile phone.

8. A method of playing a game of live bingo, the method comprising:
distributing at least one bingo card;
taking a picture of the at least one bingo card with a portable computing device wherein the portable computing device is a mobile phone; and
using the portable computing device to play a game of live bingo, the portable computing device configured to take a picture of the at least one bingo card and store the image of the bingo card, receive an indication of a ball in play during a game of live bingo, determine if the image has an indication of a ball in play printed on the image;
recognize when a winning bingo pattern exists for the image based on the received indications of a ball in play and the indications printed on the loaded bingo card; and
alert a user of the portable computing device when a winning bingo pattern exists for the loaded bingo card.

9. The method of claim 8 wherein:
distributing at least one bingo card comprises distributing at least a first bingo card and a second bingo card wherein the first and second bingo cards are different;
taking a picture of the at least one bingo card with a portable computing device comprises taking a picture of the first bingo card with a first portable computing device wherein the first portable computing device stores a first image of the first bingo card and the first portable computing device is a mobile phone and taking a picture of the second bingo card with a second computing device wherein the second portable computing device stores a second image of the second bingo card and the second portable computing device is a mobile phone;
playing a game of live bingo; and
using the portable computing device to play a game of live bingo comprises using the first portable computing device to play a game of live bingo using the first image and using the second portable computing device to play the game of live bingo using the second image.

10. The method of claim 9 wherein using the portable computing device to play a game of live bingo comprises manually inputting an indication of a ball in play to at least one of the portable computing devices using an input device of the portable computing device.

11. The method of claim 9 further comprising transmitting an indication of a ball in play over a network, wherein using the portable computing device to play a game of live bingo comprises at least one of the portable computing devices receiving over the network the indication of a ball in play.

12. The method of claim 9 further comprising using sound to indicate a game in play wherein using the portable computing device to play a game of live bingo comprises at least one of the portable computing devices receiving a sound input of a ball in play and the portable computing device using voice recognition to determine the ball in play.

13. The method of claim 9 wherein playing a game of live bingo comprises outputting the ball in play from a hopper.

14. The method of claim 9 wherein using the portable computing device to play a game of live bingo comprises the first and second portable computing devices determining if the first and second image, respectively, has an indication of ball in play printed thereon; recognizing when a winning bingo pattern exists for the first and second image, respectively, based on the received indications of a ball in play and the indications printed on the first and second image, respectively; and alerting a respective user of the first and second portable computing devices when a winning bingo pattern exists for first and second bingo cards, respectively.

15. The method of claim 9, further comprising at least one of the portable computing devices reporting a winning bingo pattern over a network to a central computing device.
